(19) United States
(12) Patent Application Publication
(10) Pub. No.: US 2023/0224166 A1
(43) Pub. Date: Jul. 13, 2023

(54) Systems and Methods for Associating Digital Media Files with External Commodities

(71) Applicant: SnekTech, Inc., Seattle, WA (US)

(72) Inventor: Carly Rector, Seattle, WA (US)

(21) Appl. No.: 18/061,217

(22) Filed: Dec. 2, 2022

Related U.S. Application Data
(60) Provisional application No. 63/285,678, filed on Dec. 3, 2021.

(51) Int. Cl. H04L 9/32

(52) U.S. Cl. CPC H04L 9/3247; G06Q 2220/18

(57) ABSTRACT

A computer-implemented system for associating digital media files with external commodities wherein a digital media file such as digital art is provided. An external commodity that is unique and has a unique identifier is provided, such as a carbon credit. Ownership of the external commodity is transferred to a buyer when the digital media file is acquired by the buyer. The digital media file is associated with the external commodity by generating a digital signature using a private key from data that includes a hash of the digital media file and the unique commodity identifier. A new, unique digital file is created containing the digital signature as metadata.

### CROSS-REFERENCE TO RELATED APPLICATIONS

This application is a non-provisional application that claims the benefit of priority of U.S. provisional patent application No. 63/285,678, filed on Dec. 3, 2021, which is incorporated by reference in its entirety

### FIELD OF THE DISCLOSURE

This disclosure relates generally to computer-implemented systems and methods for associating digital media files with external commodities.

### BACKGROUND

Digital signatures are widely used to verify that content was created by an authorized entity. Various methods exist to verify the provenance and/or copyright of a digital media file via a digital signature embedded in the file's metadata. Such “forgery-prevention” digital signatures only contain data related to the file itself or its provenance. Existing digital signature methods for digital media generally do not identify unique instances of the file being digitally signed, such as a user or purchase identifier, and identifiers used in the digital signature have no associated value (they are not associated with a unique external commodity). For these reasons, digital artists struggle to monetize their work because it's free to copy and indistinguishable from the original.

Existing methods of monetizing unique instances of digital media by tokenization (e.g., NFTs—non-fungible tokens) involve associating an instance of a file with a unique token tracked on a distributed blockchain ledger. This token may have some value because it carries a verifiable method to track ownership but doesn't otherwise have value beyond its association with the media. In addition, while each unique token references the media, the media itself does not necessarily reference the token, and each purchase does not necessarily confer a unique media file. Moreover, there can be substantial overhead costs, energy use, and environmental impact associated with the blockchain and “minting” NFTs.

There are no existing methods for using an authorized digital signature to associate a digital media file with an existing external commodity that already has value.

With reference to the particular application of digital art, it's difficult for digital artists to sell their art in the same way that traditional artists do. Digital artists face fundamental challenges when compared to traditional artists. By the nature of the Internet, it's impossible to view digital art online without also acquiring it: when you see an image online, it's downloaded to your computer. That means digital artists must monetize their work in other ways than directly showing and then selling pieces of art. Common strategies used by digital artists include patronage (i.e., websites that offer the ability to buy a subscription or give a donation to an artist directly in return for exclusive content and insight and the like), sales of physical merchandise via print-on-demand services; commissions to create original digital works to a client's specifications and their exclusive use; and licensed stock images. However, none of these solutions are appealing to a casual art fan who wants to easily browse and enjoy a variety of images, and who may be willing to pay for a favorite piece but is not interested in physical merchandise or becoming a patron and does not want to give money away “for nothing”.

The recent surge in sales of digital art NFTs speaks to the market need. Individual NFTs have sold for exorbitant sums. NFTs allow digital artists to sell their work in a way that wasn't possible before and they allow reliable tracking of ownership. NFT stands for “non-fungible token.” Something being non-fungible means that it is not interchangeable with other things. A dollar bill is fungible; you can trade one for another and it doesn't matter. Art is non-fungible; you can't just exchange one painting for another—they're different. Digital art, however, can have infinite, identical copies. If you purchase a copy of an image and download it, it is not any different from other copies of the image online, which can make it difficult to feel like it is worth paying for. When you buy an NFT, the actual art still isn't any different from other copies of it on the Internet, but your NFT is different from any other NFT. The NFT is provably unique. While that may not seem important, it is sometimes enough for something to be worth more. Consider numbered editions, or any other collector's item where being “one of a kind” is a selling point.

The ability to prove unique ownership without the need to rely on any centralized authority is the key selling point of NFTs. Certainly, any retailer could label image files as #1, #2, etc., and offer those for sale as numbered editions, but nothing stops someone from copying image #1 and claiming that they own it. Only the retailer that made the sale can verify who bought it, and if the retailer gets hacked, goes down, or goes out of business, that is meaningless. When using a widely adopted blockchain, all changes in NFT ownership are recorded publicly on thousands of computers across the world in a way that cannot be altered.

There are, however, substantial concerns and bad press around NFTs. The NFT itself isn't a piece of art; an NFT is a “deed” to a piece of art. You can verifiably own an NFT, that is, the deed. But whether that deed confers any rights or ownership over the associated art is less clear. Essentially, you own a certificate that says “#1 Copy of [Work].” Currently, there are no standards in place that make this deed mean anything. Anyone can write up a certificate; they don't have to have any rights over the art. All the deed proves is that someone was willing to invest in the effort in creating it and deciding to attach it to this particular piece of art. The terms and conditions of an NFT sale can provide more (such as a download, exclusivity rights, or a physical copy) but nothing about that is guaranteed by the NFT itself and it is not consistent across platforms.

Moreover, the art is separate from the NFT and can potentially be lost. Most NFTs do not actually store art on the blockchain; it would be far too expensive. Instead, an NFT identifies the art with metadata such as a URL. There are currently no standards for how this metadata should be specified or how the art should actually be stored. If your NFT uses a normal URL—as many of the most popular platforms do—and whoever is hosting the image removes it, you could end up with a “deed” that points to nothing and have no way to verify what it was originally referring to, even if you have a copy of the art yourself.

As noted above, when you own an NFT, you own a token of ownership. The focus is on ownership, selling and trading, and not on viewing or displaying. There is nothing about NFTs that changes the nature of the content sold or prevents it from being shared in other ways; the art can still be viewed for free on the Internet. Anything that “displays NFTs” could just as easily show any image or media and be indistinguishable from a human observer. For these reasons, NFTs will likely continue to have appeal to those whose interest in collecting art is demonstrating ownership and knowing it has value but will continue to seem confusing and meaningless to those with focus on content.

And drawing up that “deed” can be very wasteful of energy. Fundamentally, the way a blockchain functions is by having a network of independent participants and requiring a consensus among them for each action taken. To maintain the decentralized reliability guarantees of blockchain, a transaction must be computed and verified hundreds of times across a distributed system that is not all controlled by one entity. Bitcoin, for example, consumes more energy than many small countries in this process of “minting” coins or tokens. This becomes even more expensive if you need to guarantee permanent, distributed storage of the art itself.

The historical environmental impact and energy use of blockchain, as well as the focus on ownership rather than content, have created strong negative sentiment in portions of the online art community. There is a strong need for a truly environmentally friendly alternative. Many art appreciators are not likely to purchase NFTs and are interested in new ways to support artists monetarily and may be willing to spend more on digital art that is environmentally friendly.

Carbon credits, also known as carbon offsets, represent efforts to reduce greenhouse gas emissions. One credit represents one metric ton of CO₂ or equivalent greenhouse gases. Voluntary carbon credits are not based on regulatory requirements; they are purchased voluntarily by organizations or individuals wishing to offset their own emissions to “net-zero” or “carbon neutral” for ideological or PR purposes. Currently, consumer awareness of carbon credits is low and consumer carbon credit sales often lack transparency as to what project is being funded. There is very little incentive to purchase carbon credits as an individual, so consumer purchases are extremely rare. Associating a purchase of carbon credits with a unique piece of art will increase awareness and demand.

### SUMMARY

One or more embodiments described herein allow a digital media file, such as digital art, to be monetized as a proxy for some existing external commodity of monetary value, such as a carbon credit. A simple, low-cost method is provided for an authorized system to market digital media that is associated with commodities with existing value and it allows buyers to possess a unique digital media file. By associating the digital media file with a unique external commodity, buying a “signed copy” of a digital media file has value to buyers.

In one embodiment, a computer-implemented system and method is provided for associating digital media files with existing, external commodities unique to that instance of the media file. In one implementation, the digital media file is digital artwork (an image file), and the external commodity is a carbon credit. Buyers browse an online marketplace for digital artwork (or other digital media), and upon purchase, the system allocates some amount of carbon credits (or other commodity) to the buyer and transfers those credits or commodities (i.e., serial numbers or lot numbers) to an external system in the buyer's name. The commodity must have unique identifiers and be capable of transfer within an external system identifying ownership. A digital signature is generated using a private key containing the artist identifier, the buyer identifier, the carbon credit identifiers, a hash of the image, and the purchase date. A new, unique image file is created and transferred to the buyer containing the digital signature as metadata. Known techniques of digital certificates and public key infrastructures can then be used to verify the signature, which cannot be altered without the verification system identifying it as being invalid.

In one exemplary and non-limiting implementation, a new way to buy unique pieces of art online and to support both digital artists and the environment is provided. Buyers purchase “signed copies” of digital art, where half of the price goes to carbon credits, and half to the artist (plus a transaction fee). Via the inventive method of creating file metadata as described herein, each buyer receives a unique media file with a digital signature proving it was generated for them specifically and identifying carbon credits that a portion of their purchase funded. Each set of carbon credits is unique, and buyers can see what specific carbon-reduction project their credits came from—including efforts like reforestation, upgrading stoves in developing countries, or storing carbon in concrete. For buyers, it allows even casual art fans to feel good by supporting art they are already enjoying, funding causes they care about, and creating a collection of unique art. For artists, it makes it easy to monetize their work in a way that aligns with their principles. Embodiments of this invention provide an alternative to digital art NFTs when the benefits of blockchain are outweighed by the costs.

In view of the above, one aspect of this disclosure is an electronic device comprising one or more memories including processor readable instructions stored thereon, and one or more processors configured to read the processor readable instructions to cause the electronic device to implement a method for associating digital media files with external commodities. The method comprises providing a digital media file; providing an external commodity that is unique and has a unique commodity identifier; transferring ownership of the external commodity to a buyer when the digital media file is acquired by the buyer; associating the digital media file with the external commodity by generating a digital signature using a private key from data that includes a hash of the digital media file and the unique commodity identifier; and creating a new, unique digital file containing the digital signature as metadata.

Another aspect of this disclosure is a method for associating digital media files with external commodities. The method is implemented by one or more memories having processor readable instructions stored thereon, and one or more processors configured to execute the processor readable instructions. The method comprises providing a digital media file; providing an external commodity that is unique and has a unique commodity identifier; transferring ownership of the external commodity to a buyer when the digital media file is acquired by the buyer; associating the digital media file with the external commodity by generating a digital signature using a private key from data that includes a hash of the digital media file and the unique commodity identifier; and creating a new, unique digital file containing the digital signature as metadata.

A further aspect of this disclosure is a non-transitory processor-readable medium encoded with instructions for associating digital media files with external commodities. The instructions comprise providing a digital media file; providing an external commodity that is unique and has a unique commodity identifier; transferring ownership of the external commodity to a buyer when the digital media file is acquired by the buyer; associating the digital media file with the external commodity by generating a digital signature using a private key from data that includes a hash of the digital media file and the unique commodity identifier; and creating a new, unique digital file containing the digital signature as metadata.

Other aspects and advantages will be apparent from the following description and appended claims.

### BRIEF DESCRIPTION OF THE DRAWINGS

Embodiments of the invention are described in detail below with reference to the following drawings. The drawings are for illustrative purposes only of selected embodiments, do not show all possible implementations, and are not intended to limit the scope of this description.

FIG. 1 is a flowchart that illustrates a method according to one embodiment for associating digital media files with unique external commodities.

FIG. 2 is a conceptual block diagram illustrating a high-level architecture implementing the method of FIG. 1 as well as other aspects of the embodiments described herein.

FIG. 3 is a conceptual block diagram showing digital signature generation and verification flow according to an embodiment.

FIG. 4 is a table setting forth a data schema according to embodiments described herein.

FIG. 5 is a table setting forth image metadata fields according to embodiments described herein.

FIG. 6 illustrates an exemplary system for one or more computing devices that may be employed in practicing one or more non-limiting embodiments described herein.

### DETAILED DESCRIPTION

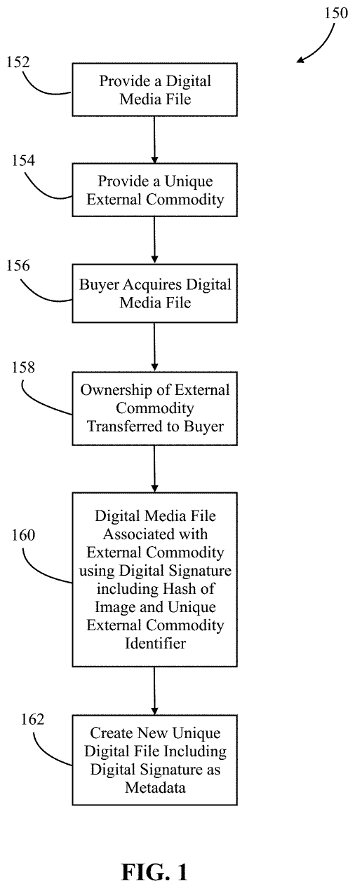

FIG. 1 is a flowchart that illustrates a method 150 according to one embodiment for associating digital media files with unique external commodities. In step 152, a digital media file is provided, and in step 154, a unique external commodity is provided. In one non-limiting implementation, the digital media file is digital artwork (an image file) and the external commodity is a carbon credit. In step 156, a buyer acquires (such as by purchasing) the digital media file. This may occur, for example, when the buyer browses an online marketplace for digital artwork (or other digital media). Upon purchase, in step 158, the system allocates ownership of an external commodity (carbon credits, for example) to the buyer and transfers those credits or commodities (i.e., serial numbers or lot numbers) to an external system in the buyer's name. The commodity must have a unique identifier and be capable of transfer to an external system identifying ownership. The external system must own these commodities or be otherwise authorized to transact them. In order to associate the digital media file with the external commodity, in step 160, a digital signature is generated using a private key containing at least a hash of the image (or other media file) and the unique identifier of the external commodity (such as the carbon credit identifiers, if appropriate). The digital signature may also optionally include the artist identifier, the buyer identifier, and the purchase date. A new, unique digital file containing the digital signature as metadata is created in step 162 and transferred to the buyer.

A separate verification system allows users in possession of a media file to check if the file contains a valid signature created by the authorized system. This verification system may use known techniques of digital certificates and public key infrastructures to verify the signature. Even if a media file is transferred or copied, the signature cannot be altered by an unauthorized system without the verification system identifying it as invalid. Thus, as long as a signature is verified to be valid, the commodity identifiers cannot have been altered from the original sale. If the external system tracking the commodities allows verification of ownership, purchase history, or other designation of an associated person, then anyone in possession of a media file with a valid signature can verify the original purchaser of the media.

Method 150 allows the sale of digital media as a proxy for or as added value to the associated commodity. A digital marketplace can offer media for sale, with a purchaser being able to download a unique file with a signature referencing particular individual commodities. The individual commodities can be transferred to, purchased on behalf of, or retired on behalf of, the user who purchased the media.

Embodiments disclosed herein generally involve the following aspects:

Media upload, storage, and checksum generation: Image or other media files are uploaded by the artist and stored in online servers. The artist also provides a description, chooses a list price, and provides a name to be used for signatures. The uploaded images are given unique identifiers and a hash of the image content is generated.

Commodity transaction management: Unique instances of the underlying commodity are purchased from some external source, given unique identifiers (if they don't already have them), stored in a buffer/bank, and then assigned to individuals upon them making a commodity (such as art) purchase.

Marketplace website and purchase history: A user-facing marketplace website where artists list their art or other commodities and users can make purchases, as well as see past purchases and re-download media. Buyers sign up for the site, including providing a name they want any signature to be “signed to.” They may then browse the site and purchase “signed copies” of images they want. In one implementation, when a purchase occurs, the system allocates half the purchase price worth of carbon credits to the buyer and “retires” those credits in the buyer's name in the external system where they were sourced from (e.g., Verra registry).

Certificate authority: The system is issued digital certificate(s) by a trusted certificate authority.

Signature generation: A string is generated containing the artist identifier, the buyer identifier, a hash of the image, the purchase date, and the carbon credit identifiers (if applicable). This string is then “signed” by a digital certificate.

File generation: A new, unique media file is generated that includes both the main content uploaded by the artist (the image file) and the signature data as metadata. The buyer can return to the site at a later point to view information on their purchase and re-download the file. They can view information in the external registry that says the associated credits were retired in their name. If they upload the file, anyone with access to it can use the verification system to check if the file was validly signed by this system, and if so to who.

Signature verification: Via a publicly accessible site and/or open-source code, any file can be checked to see if it has a valid signature. A valid signature: a) can be decrypted using a public key validated by the trusted certificate authority, b) matches any unencrypted identifier metadata, and c) contains a hash that matches that of the media. If all these are true, the file and metadata has not been altered since the authorized system signed it, and therefore the authorized system associated the commodities identified in the inscription with this particular file.

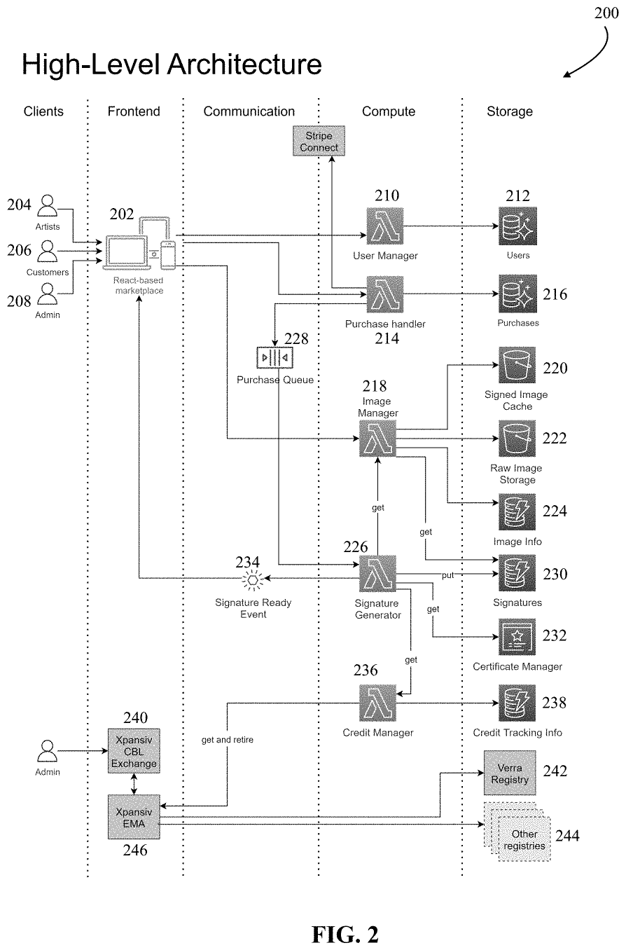

FIG. 2 is a conceptual block diagram illustrating a high-level architecture 200 implementing method 150 of FIG. 1 as well as other aspects and features.

Front End UX (User Experience): The front end includes a react-based marketplace 202 implementing all the basic functionality of a two-sided marketplace, allowing artists 204 to list their work for sale; customers (buyers) 206 to buy works, download works and view their order history; and administrators 208 to access the system. In one implementation, the front-end interacts with the rest of the back-end system via REST APIs. A REST API (also known as a RESTful API) is an application programming interface (API or web API) that conforms to the constraints of the REST (representational state transfer) architectural style and allows for interaction with RESTful web services.

User Manager: There are at least two types of users 212: artists 204, who can list art; and buyers 206, who can purchase art. Artists 204 are initially onboarded on an invite-only basis. User manager 210 manages users 212 including artists 204 and buyers 206.

Purchase Handler: Purchase handler 214 processes purchases 216 by buyers 206, allocates proceeds as required to artists 204, carbon credits and transaction fees. Carbon credits may be allocated based on a configurable price per credit.

Image Manager: Image manager 218 handles all image operations. When an image is uploaded to create a listing, image manager 218 creates an image ID and, in one implementation, associates it with the S3 URI of that raw image. The image ID is included in the product listing (image info 224). Image manager 218 also generates a hash of each image content. When a user retrieves their signed image, image manager 218 reads the signature table 230, retrieves the raw image from raw image storage 222, and creates an image file with the appropriate signature in the metadata, which is likely cached in signed image cache 220 for a short period. Image manager 218 also returns image hashes based on image ID to signature generator 226.

Signature Generator: When an order is submitted in the system, signature generator 226 posts a message to purchase queue 228 that contains the image ID, artist name, recipient name, and number of credits to use. Signature generator 226 reads off the purchase queue 228. For each purchase, signature generator 226 retrieves the appropriate number of credits from credit manager 236, including their identifiers, and the info for the purchased image—identifier and hash. Signature generator 226 generates an inscription string containing the artist, the purchaser, the credits, and the image hash, and digitally signs the string with a private key. This signature is then stored in signature table 230. An event notification 234 may be generated indicating that the signature is ready.

Credit Manager: Credit manager 236 purchases credits manually by interacting with an exchange platform 240 for transacting energy and environmental commodity products such as carbon credits. In one implementation, exchange platform 240 is the Xpansiv CBL exchange. This may occur, in one implementation, by trading in GEO (global emissions offset) or N-GEO (nature-based global emissions offset) contracts. When purchases are made, credits are transferred from the seller's registry account to the system registry 242. In one implementation, system registry 242 is the Verra Registry. Other registries 244 may alternatively be used. The registry used must maintain a “bank” of credits to fulfill orders. EMA (Environmental Management Account) 246 may provide a management user interface for viewing and retiring environmental assets, such as the Xpansiv EMA. Credit manager 236 maintains a facade for service interactions. It selects credits, assigns them to the purchase, and retires them in the registry on behalf of the purchaser.

Digital Signature Overview

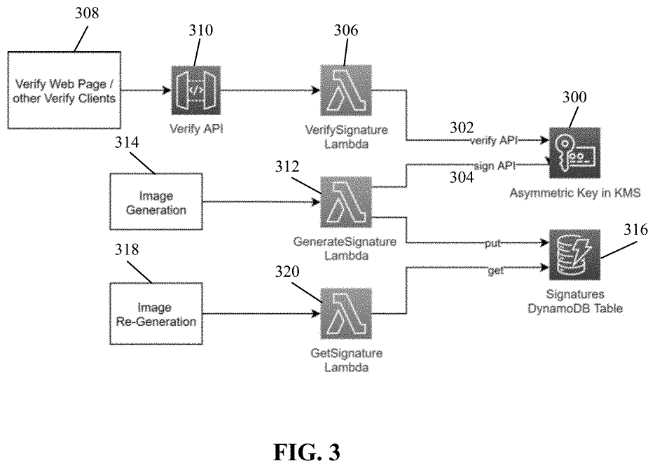

FIG. 3 is a conceptual block diagram showing digital signature generation and verification flow according to an embodiment. Digital signatures are generated via asymmetric key encryption 300: a message is encrypted (“signed”) using a private key and decrypted with a public key. Anyone has access to the public key and can decrypt the message, but without access to the private key, no one else can generate a message that the public key can decrypt. In one implementation, AWS (Amazon Web Services) KMS (Key Management Service) verify (302) and sign (304) APIs are used for this.

The message being encrypted for private key signature is referred to as the “inscription,” and it includes the artist name, buyer name, carbon credit data, and an image checksum. Public keys are posted on a verified platform or website. Therefore, if an inscription decrypted by the public key matches the expected inscription, it can be validated that (1) the message was signed by the private key; and (2) the inscription has not been changed since it was signed. From this it can be derived that: (1) the image has not been changed; (2) the artist name has not been changed; (3) the buyer name has not been changed; and (4) the carbon credit data has not been changed.

To verify that a signed image is valid (306): (1) the signature must be decrypted and a check made that it matches the expected encryption; and (2) a check must be made that any of the human-readable metadata fields on the image also match the encryption. A validation page 308 may be provided where users can easily upload an image and check to see whether it's valid. In addition, an API 310 and/or library code may be provided for other parties to use. Everything necessary to validate is made publicly available.

Signatures are generated (312) when a buyer first purchases an image (314) and are stored for reference in a data schema table 316. If a buyer later wants to re-download the image, there may or may not be a signed copy of the image already available. If the signed copy of the image is not available, it's simple to re-generate the image (318) by retrieving the signature (320) from the database 316 and adding it as metadata to the base image again.

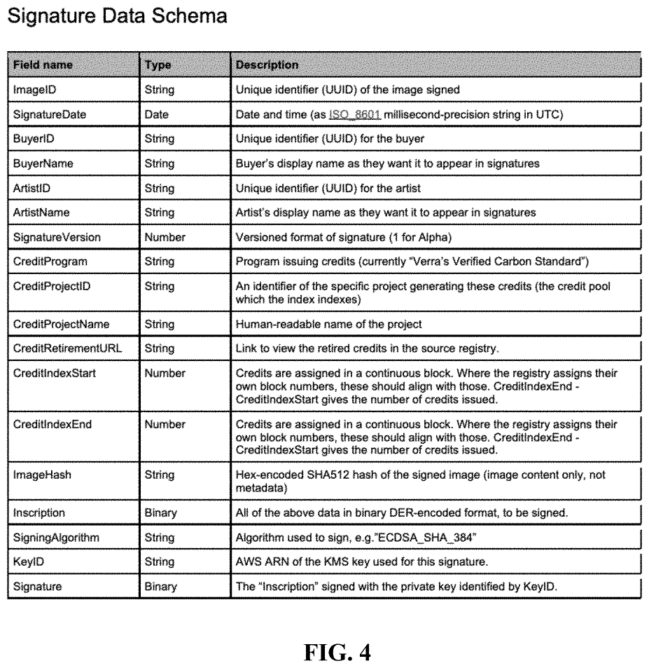

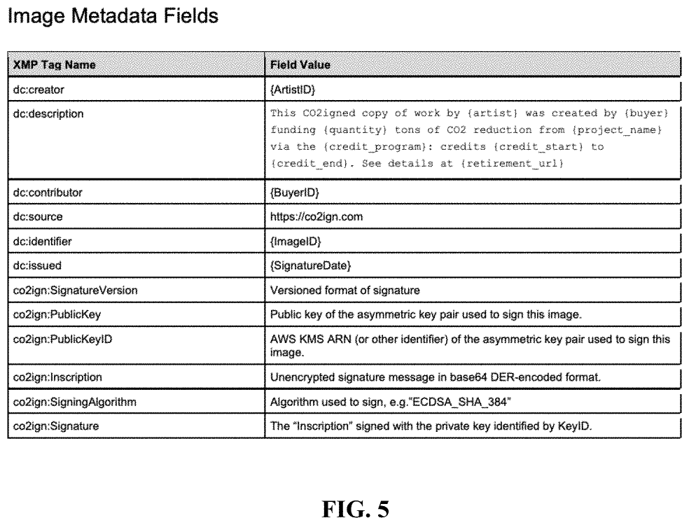

In conjunction with the digital signature generation and verification flow of FIG. 3, FIG. 4 is a table setting forth the data schema and FIG. 5 is a table setting forth image metadata fields.

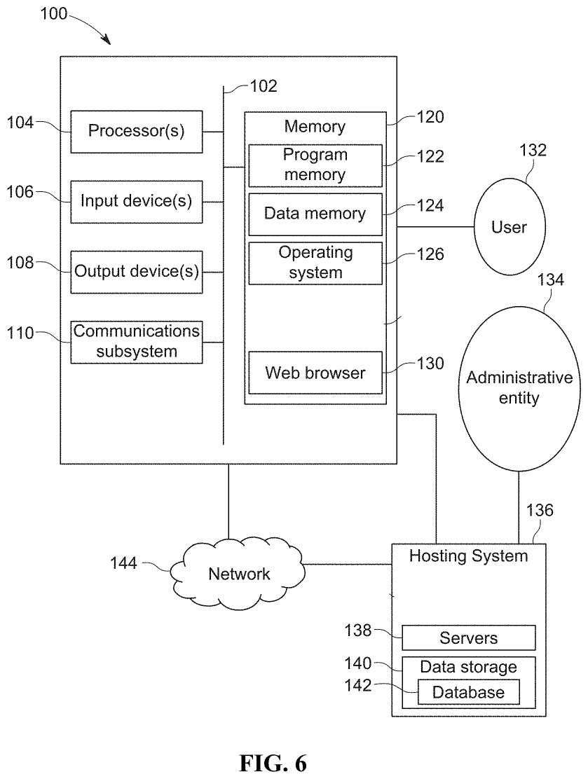

FIG. 6 illustrates an exemplary system for one or more computing devices 100 and the various exemplary components that may be employed in practicing one or more non-limiting embodiments as described above. Some or all of method 150 (FIG. 1); architecture 200 (FIG. 2) and the digital signature verification/generation scheme of FIG. 3, for example, may be incorporated in one or more computing devices such as computing device 100 of FIG. 6. Computing device 100 may be any type of computing device known or to be created in the future. This may include, without limitation, fixed in place computers, such as desktop computers or mobile computing devices. Mobile computing devices may include, but are not limited to, laptop computers, smartphones and mobile phones, tablets, or any other type of mobile electronic, computing device.

FIG. 6 provides a schematic illustration of one embodiment of a computing device 100 that can perform and implement the methods and architectures disclosed herein, and/or can function as the host computer system, a remote kiosk/terminal, a point-of-sale device, a mobile device, a set-top box and/or a computer system. FIG. 6 is meant only to provide a generalized illustration of various components, any or all of which may be utilized as appropriate. FIG. 6, therefore, broadly illustrates how individual system elements may be implemented in a relatively separated or relatively more integrated manner.

Computing device 100 may be any type of information handling system, including, but not limited to, any type of computing device as noted above. To reiterate, this may include small handheld devices, such as handheld computer/mobile telephones or may include large mainframe systems, such as a mainframe computer. Other examples of computing devices 100 may include, but are not limited to, laptops, notebooks, workstation computers, personal computer systems, as well as servers (e.g., servers 138). Computing devices 100 can be used by various parties described herein and may be connected on a computer network, such as computer network 144. Types of computer networks that can be used to interconnect the various information handling systems may include, but are not limited to, Local Area Networks (LANs), Wireless Local Area Networks (WLANs), the Internet (e.g., World Wide Web), the Public Switched Telephone Network (PSTN), other wireless networks, and any other network topology that can be used to interconnect the information handling systems.

The computing device 100 is shown comprising hardware elements that can be electrically coupled via a bus 102 (or may otherwise be in communication, as appropriate). The hardware elements of computing device 100 may include one or more processors 104, including without limitation one or more general-purpose processors and/or one or more special-purpose processors (such as digital signal processing chips, graphics acceleration processors, and/or the like). Computing device 100 may further include one or more input devices 106, which can include without limitation one or more cameras, sensors (including inertial sensors), a mouse, a keyboard, and/or the like, which may be utilized in the implementation of various aspects of the embodiments.

In addition to the above, computing device 100 may include one or more output devices 108 such as a device display. In some embodiments, an input device 106 and an output device 108 of computing device 100 may be integrated, for example, in a touch screen or capacitive display as commonly found on mobile computing devices as well as desktop computers and laptops.

Processors 104 may have access to a memory such as memory 120. Memory 120 may include one or more of various hardware devices for volatile and non-volatile storage and may include both read-only and writable memory. For example, memory 120 may comprise random access memory (RAM), CPU registers, read-only memory (ROM), and writable non-volatile memory, such as flash memory, hard drives, floppy disks, CDs, DVDs, magnetic storage devices, tape drives, device buffers, and so forth. A memory 120 is not a propagating signal divorced from underlying hardware; a memory is thus non-transitory. Memory 120 may include program memory such as program memory 122 capable of storing programs and software, such as operating system 126 and other computerized programs or application programs. Memory 120 may also include data memory such as data memory 124 that may include database query results, configuration data, settings, user options or preferences, etc., which may be provided to program memory 122 or any element of computing device 100.

The computing device 100 may further include (and/or be in communication with) one or more non-transitory storage devices, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like. Device storage may be used in a number of embodiments discussed herein. Further, the storage devices may be non-volatile data storage devices in one or more non-limiting embodiments. Further, computing device 100 may be able to access removable nonvolatile storage devices that can be shared among two or more information handling systems (e.g., computing devices) using various techniques, such as connecting the removable nonvolatile storage device to a USB port or other connector of the information handling systems.

The computing device 100 might also include a communications subsystem 110, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 110 may permit data to be exchanged with a network (e.g., such as network 144), other computer systems, and/or any other devices.

The computing device 100 also can comprise software elements, shown as being currently located within the memory 120, which in some instances may include an operating system 126, device drivers, executable libraries, and/or other code, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer). In an aspect, then, such code and/or instructions can be used to configure and/or adapt computing device 100 to perform one or more operations in accordance with the described methods.

A set of these instructions and/or code might be stored on a computer-readable storage medium, such as the storage device(s) described above. In some cases, the storage medium might be incorporated within a computer system, such as computing device 100. In other embodiments, the storage medium might be separate from computing device 100 (e.g., a removable medium, such as a compact disc or USB stick), and/or be provided in an installation package, such that the storage medium can be used to program, configure, and/or adapt a general-purpose computer with the instructions/code stored thereon. These instructions might take the form of executable code, which is executable by the computing device 100 and/or might take the form of source and/or installable code, which, upon compilation and/or installation on the computing device 100 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Some embodiments may employ a computer system (such as the computing device 100) to perform methods in accordance with the disclosure. For example, some or all of the procedures of the described methods may be performed by the computing device 100 in response to one or more processors 104 executing one or more sequences of one or more instructions (which might be incorporated into the operating system 126 and/or other code contained in the memory 120). Such instructions may be read into the memory 120 from another computer-readable medium, such as one or more of the storage device(s). Merely by way of example, execution of the sequences of instructions contained in the memory 120 may cause the one or more processors 104 to perform one or more procedures of the methods described herein.

The terms “machine-readable medium” and “computer-readable medium,” as used herein, refer to any medium that participates in providing data that causes a machine to operate in a specific fashion. In an embodiment implemented using the computing device 100, various computer-readable media might be involved in providing instructions/code to the one or more processors 104 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media may include, for example, optical and/or magnetic disks which may be an example of storage devices. Volatile media may include, without limitation, dynamic memory, which may be a type of memory included in memory 120. Transmission media may include, without limitation, coaxial cables, copper wire and fiber optics, including the wires that comprise the bus 102, as well as the various components of the communications subsystem 110 (and/or the media by which the communications subsystem 110 provides communication with other devices). Transmission media can also take the form of waves (including without limitation radio, acoustic, and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 104 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 100. These signals, which might be in the form of electromagnetic signals, acoustic signals, optical signals, and/or the like, are all examples of carrier waves on which instructions can be encoded, in accordance with various aspects of the embodiments.

The communications subsystem 110 (and/or components thereof) generally will receive the signals, and the bus 102 then might carry the signals (and/or the data, instructions, etc. carried by the signals) to the memory 120, from which the one or more processors 104 retrieves and executes the instructions. The instructions received by the memory 120 may optionally be stored on a non-transitory storage device either before or after execution by the processor(s) 104.

In one or more embodiments, computing device 100 is in communication with one or more networks, such as network 144. Network 144 may include a local area network (LAN), such as a company Intranet, a metropolitan area network (MAN), or a wide area network (WAN), such as the Internet or World Wide Web. Network 144 may be a private network, a public network, or a combination thereof. Network 144 may be any type of network known in the art, including a telecommunications network, a wireless network (including Wi-Fi), and a wireline network. Network 144 may include mobile telephone networks utilizing any protocol or protocols used to communicate among mobile digital computing devices (e.g., computing device 100), such as GSM, GPRS, UMTS, AMPS, TDMA, or CDMA. In one or more non-limiting embodiments, different types of data may be transmitted via network 144 via different protocols. In further non-limiting other embodiments, computing device 100 may act as a standalone device or may operate as a peer machine in a peer-to-peer (or distributed) network environment.

Network 144 may further include a system of terminals, gateways, and routers. Network 144 may employ one or more cellular access technologies including but not limited to: 2nd (2G), 3rd (3G), 4th (4G), 5th (5G), LTE, Global System for Mobile communication (GSM), General Packet Radio Services (GPRS), Enhanced Data GSM Environment (EDGE), and other access technologies that may provide for broader coverage between computing devices if, for instance, they are in a remote location not accessible by other networks.

In one or more non-limiting embodiments, a computing device, such as computing device 100 may include a web browser such as web browser 130. Web browser 130 may be any type of web browser known in the art that may be used to access one or more web applications on user computing devices 100 or the like. Web applications are applications that are accessible by network 144 and may be located on the Internet or World Wide Web. Web browser 130 may include a variety of hardware, software, and/or firmware generally operative to present a web application to a user via a display device 108 (e.g., touchscreen or other type of monitor or display device) on a computing device. Examples of suitable web browsers include, but are not limited to, MICROSOFT EXPLORER, MOZILLA FIREFOX, and APPLE SAFARI. Web browser 130 may be previously installed by the manufacturer or company associated with the computing device 100, or alternatively, may be downloaded onto computing device 100 or any other computing device. Web browser 130 may be stored in a separate storage device and/or memory 120.

In one or more non-limiting embodiments, one or more aspects of the embodiments described herein may be implemented as a web service. As known in the art, a web service may be a software module or software program that is designed to implement a set of tasks that is accessible from multiple computing devices, such as computing device 100 over a network, such as network 144. In particular, one or more features may be implemented as a web service accessible using the World Wide Web as the connecting network 144, although any alternative type of network may be used. When implemented as a web service, various aspects such as marketplace 202 can be searched for by users 132 (e.g., artists or buyers) using web browser 130. When implemented as a web service, embodiments can be searched for over the network 144 using the input devices 106 of a computing device and can also be invoked accordingly. Further, when invoked as a web service, various aspects of the embodiments would be able to provide functionality to the user who invoked that web service.

When implemented as a web service, a user may invoke a series of web service calls via requests to one or more servers 138 that are part of the hosting system 136 which would host the actual web service. In one or more non-limiting embodiments, hosting system 136 may be a cloud-based type hosting system. “Cloud-based” is a term that refers to applications, services, or resources made available to users on demand via a network, such as network 144, from a cloud computing provider's server. In one non-limiting embodiment, administrative entity 134 may be the cloud computing provider and may use servers 138 to provide access to aspects of the described embodiments.

Hosting system 136 may include data storage systems 140 that can provide access to stored data by applications running on computing devices (e.g., 100) that may be geographically separate from each other, provide offsite data backup and restore functionality, provide data storage to a computing device with limited storage capabilities, and/or provide storage functionality not implemented on a computing device (e.g., 100).

The hosting system 136 may be a service that can be implemented as a web service, in one or more non-limiting embodiments, with a corresponding set of Web Service Application Programming Interfaces (APIs). The Web Service APIs may be implemented, for example, as a Representational State Transfer (REST)-based Hypertext Transfer Protocol (HTTP) interface or a Simple Object Access Protocol (SOAP)-based interface. Any programming languages may be used to implement aspects of the described embodiments as a web service, including, but not limited to .Net, Java, and XML. Further, a web service may use standardized industry protocol for the communication and may include well-defined protocols, such as Service Transport, XML Messaging, Service Description, and Service Discovery layers in the web services protocol stack.

For instance, the hosting system can be implemented such that client applications (for example, executing on computing device 100) can store, retrieve, or otherwise manipulate data objects in the hosting system 136. The hosting system 136 can be implemented by one or more server devices 138, which can be implemented using any type of computing device.

In one or more non-limiting embodiments, administrative entity 134 is the provider and creator of certain aspects of the described embodiments. Administrative entity 134 may provide an application programming interface for use by users 132. Administrative entity 134 may be able to manipulate and alter the interface to affect its operation and maintenance on server(s) 138 and as stored on one or more data storage devices 140 that are part of the hosting system 136. Data storage devices 140 included for storing any data associated with the described embodiments may include one or more databases 142 that store live and historical data in one or more non-limiting embodiments. Data storage devices 140, via databases 142 in some cases, may be able to store all data obtained from users 132. While administrative entity 134 is depicted as a single element communicating over network 144 and through the hosting system 136, it is noted that administrative entity 134, in one or more non-limiting embodiments, may be distributed over network 144 in any number of physical locations.

In one or more non-limiting embodiments, various aspects may alternatively be implemented as a downloadable software module that is capable of being stored directly on a computing device, such as computing device 100, rather than acting as a web service accessible through a computing device's web browser 130. Accordingly, user 132 may be able to download and store aspects of the described embodiments on computing device 100 as a computer-based application and software module that runs using the working engines and modules on the computing device. Some aspects of the embodiments may be preinstalled on computing device 100 or any other computing device by the manufacturer or designer or other entity. Aspects of the embodiments may be innate, built into, or otherwise integrated into existing platforms such as, without limitation thereto, a website, third-party program, iOS™ Android™ or any other platform capable of transmitting, receiving, and presenting data.

Aspects of the embodiments may be stored on computing device 100 or any other computing devices and may also be stored or otherwise accessible by one or more servers 138 over network 144 by any party. The storage devices may include a non-transitory computer readable medium including instructions, which when executed by a computer or processor (such as processors 104) may cause the computer or processor to perform operations to implement the described embodiments. Additionally, or alternatively, various features of the described embodiments may be a software application that is downloadable and usable from any type of mobile computing device 100.

As shown in FIG. 6, computing device 100 may belong to a user referred to in FIG. 6 such as user 132. User 132 may be an artist, buyer or any other user accessing the described embodiments using his or her computing device 100.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention. Accordingly, additional components known to one of ordinary skill in the art, even if not illustrated in FIG. 6, may also be included in computing device 100.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

While embodiments of this disclosure are envisioned primarily in a non-blockchain environment, aspects of this disclosure could alternatively be used as a method for associating a unique media file with a token created to identify it, linking the file itself back to the token on the blockchain.

While embodiments of this disclosure are not envisioned for use directly as a copyright protection or as a digital fingerprinting technique, because signature metadata can easily be removed from a file, in a system that disallowed any media without a valid signature, it could provide a way that only validly purchased media can be stored or displayed, potentially including data on the purchaser.

While aspects of this disclosure, such as image storage and the marketplace website, are primarily envisioned as continuing digital presences, they could alternatively be replaced by more manual or ephemeral systems.

While this disclosure has been discussed primarily with respect to images, it does not need to involve images—it could be other media. Any file type that can contain medadata could be signed (for example, text), so it could be any sort of digital “collectable.” The commodity can be anything with unique identifiers that can be transferred in some external system. This could even be used in conjunction with NFTs (to include signed metadata on an image file identifying an associated NFT to complement the NFT referring to an image file.)

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention.

The embodiments were chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

1. An electronic device comprising:
one or more memories including processor readable instructions stored thereon; and
one or more processors configured to read the processor readable instructions to cause the electronic device to implement a method for associating digital media files with external commodities, comprising:
providing a digital media file;
providing an external commodity that is unique and has a unique commodity identifier;
transferring ownership of the external commodity to a buyer when the digital media file is acquired by the buyer;
associating the digital media file with the external commodity by generating a digital signature using a private key from data that includes a hash of the digital media file and the unique commodity identifier; and
creating a new, unique digital file containing the digital signature as metadata.

2. The electronic device of claim 1, wherein the digital media file is a digital artwork.

3. The electronic device of claim 2, wherein the digital artwork is provided by an online marketplace.

4. The electronic device of claim 1, wherein the external commodity is a carbon credit.

5. The electronic device of claim 4, wherein the unique commodity identifier is a serial number or lot number.

6. The electronic device of claim 1, wherein the digital signature is generated from data that includes an artist identifier, a buyer identifier, the unique commodity identifier, the hash of the digital media file, and a purchase date.

7. The electronic device of claim 1, wherein ownership of the new, unique digital file is transferred to the buyer.

8. A method for associating digital media files with external commodities implemented by one or more memories having processor readable instructions stored thereon, and one or more processors configured to execute the processor readable instructions, the method comprising:
providing a digital media file;
providing an external commodity that is unique and has a unique commodity identifier;
transferring ownership of the external commodity to a buyer when the digital media file is acquired by the buyer;
associating the digital media file with the external commodity by generating a digital signature using a private key from data that includes a hash of the digital media file and the unique commodity identifier; and
creating a new, unique digital file containing the digital signature as metadata.

9. The method of claim 8, wherein the digital media file is a digital artwork.

10. The method of claim 9, further comprising providing the digital artwork by an online marketplace.

11. The method of claim 8, wherein the external commodity is a carbon credit.

12. The method of claim 11, wherein the unique commodity identifier is a serial number or lot number.

13. The method of claim 8, wherein the digital signature is generated from data that includes an artist identifier, a buyer identifier, the unique commodity identifier, the hash of the digital media file, and a purchase date.

14. The method of claim 8, further comprising transferring ownership of the new, unique digital file to the buyer.

15. A non-transitory processor-readable medium encoded with instructions for associating digital media files with external commodities, the instructions comprising:
providing a digital media file;
providing an external commodity that is unique and has a unique commodity identifier;
transferring ownership of the external commodity to a buyer when the digital media file is acquired by the buyer;
associating the digital media file with the external commodity by generating a digital signature using a private key from data that includes a hash of the digital media file and the unique commodity identifier; and
creating a new, unique digital file containing the digital signature as metadata.

16. The non-transitory processor-readable medium of claim 15, wherein the digital media file is a digital artwork.

17. The non-transitory processor-readable medium of claim 16, further comprising instructions for providing the digital artwork by an online marketplace.

18. The non-transitory processor-readable medium of claim 15, wherein the external commodity is a carbon credit.

19. The non-transitory processor-readable medium of claim 18, wherein the unique commodity identifier is a serial number or lot number.

20. The non-transitory processor-readable medium of claim 15, further comprising instructions for generating the digital signature from data that includes an artist identifier, a buyer identifier, the unique commodity identifier, the hash of the digital media file, and a purchase date.
